(19) United States
(12) Patent Application Publication
(10) Pub. No.: US 2002/0123921 A1
(43) Pub. Date: Sep. 5, 2002

(54) System and method for fulfilling staffing requests

(76) Inventor: Charles P. Frazier, Dallas, TX (US)

Correspondence Address: Michael L. Diaz, Michael L. Diaz, P.C., 555 Republic Drive, Suite 200, Plano, TX, 75074, US

(21) Appl. No.: 09/796,840

(22) Filed: Mar. 1, 2001

(51) Int. Cl. G06F 17/60

(52) U.S. Cl. 705/9; 705/26

(57) ABSTRACT

A method and system for fulfilling staff requests. The system includes input terminals communicating with a computing system. The computing system includes a computer, a qualifications database, a requirements database, and a broadcasting module. A plurality of employees submit applications to the computing system via the input terminal. In addition, an employer, seeking a temporary employee, submits a job request having minimum qualifications via the input terminal to the computing system. The computer then matches those candidates having the minimum qualifications with the job request of the employer. The broadcasting module communicates with the selected candidates to determine if they desire to work. The first candidate to accept the job request is awarded the job. The system may also be used to match product requests from a customer to those suppliers having the requested products.

### BACKGROUND OF THE INVENTION

1. Technical Field of the Invention

This invention relates to the fulfillment of staffing requests and, more particularly, to a system and method for matching staffing requests and broadcasting staffing requests to selected parties.

2. Description of Related Art

In the existing temporary employment industry, there are staffing employment agencies which are tasked with providing employers with qualified employees on a temporary basis. A prime example where these staffing agencies are utilized can be seen in the medical field. For example, many nurses are employed at hospitals and other medical facilities on a part-time basis. Primarily, these medical facilities utilize temporary employees to accommodate the inconsistent number of patients over a period of time. If full time employees were used, medical staff would be periodically underutilized during slow times, which would not be cost-effective. However, if medical staffing is kept at a minimum during a period of time when the number of patients are high, the low staffing could result in dangerous risks to the patients. Therefore, these medical facilities utilize the temporary employees to provide the additional staffing necessary during increased usage of the medical facilities. However, to provide a readily available staff, medical facilities typically use employment agencies to find and fill these temporary job vacancies. Presently, these employment agencies find employees having specific qualifications. The employment agencies keep these employees and their associated qualifications on file. When an employer requests an employee with specific qualifications, the employment agency manually determines which employee candidates have the requested qualifications. The employment agency then commences the tedious and time-consuming task of calling these qualified employee candidates and ask if they would wish to fill the vacancy.

This step of calling and requesting the services of the employee candidates is time consuming, which is the primary reason why these employment agencies are used. The employment agency sometimes must call numerous employee candidates to find an employee candidate willing to fill the vacancy. Thus, many work hours are utilized in finding a qualified employee candidate willing to fill the requested vacancy. A system and method are needed which automatically matches the requested qualifications for a specific temporary job opening with a pool of qualified employee candidates. Additionally, a system and method are needed which selectively broadcasts the available job openings to the qualified pool of employees.

Similar problems arise in other industries, such as the manufactured goods industry. Many times, customers request specific products which are not currently available in a local store. Sometimes a store will even search within a specific region to find the requested good. Obviously, this method of finding the specific product for a customer is also tedious and expensive. Therefore, a system and method are also needed which automatically matches the requested products with the supply of products available from a plurality of suppliers. Additionally, a system and method are needed which broadcasts the product requests to the potential suppliers.

Thus, it would be a distinct advantage to have a system and method which automatically matches a request with a plurality of suppliers. Additionally, it would be advantageous to have a system and method which broadcasts the requests to the selected suppliers. It is an object of the present invention to provide such a system and method.

### SUMMARY OF THE INVENTION

In one aspect, the present invention is a system for fulfilling staffing requests of an employer. The system includes a computing system, and a first input terminal for communicating between at least one employee and the computing system. Each employee provides data on the employee's qualifications. Additionally, the system includes a second input terminal for communicating between the employer and the computing system. The employer provides a request for a job vacancy to be filled to the computing system. The request also sets a minimum qualification necessary to fill the job vacancy. The computing system selects each employee qualified to fill the job vacancy of the employer and broadcasts the job request to the selected employees. The system allows each employee to respond to the offer of the job vacancy and determines a first employee to accept the offer of the job vacancy. The computing system awards the job to the first employee to accept the offer of the job vacancy. Alternatively, the computing system, or some other party, may award the job based on other criteria.

In another embodiment of the present invention, the system is a system for fulfilling staffing requests of an employer. The system includes a computing system and a first input terminal for communicating between at least one employee and the computing system. Each employee provides data on the employee's qualifications. A second input terminal communicates between the employer and the computing system. The employer provides a request for a job vacancy to be filled to the computing system. The request includes a minimum qualification necessary to fill the job vacancy. The computing system selects each employee meeting the minimum qualification requested for the job vacancy. In addition, the system includes a broadcasting module for broadcasting to the selected employees the request of the job vacancy and allows each selected employee to respond to the request by communicating with the computing system. The computing system then determines a first employee to affirmatively respond to the request and awards the job vacancy to the first selected employee to respond affirmatively to the request.

In another aspect, the present invention is a system for fulfilling product requests of a customer. The system includes a computing system and a first input terminal for communicating between at least one supplier and the computing system. Each supplier provides data on the supplier's product. A second input terminal allows communication between the customer and the computing system. The customer provides a request for a product to the computing system. The computing system selects each supplier having the requested product of the customer and broadcasts the request to the selected suppliers. Each supplier responds to the request by communicating with the computing system. The first supplier to affirmatively respond to the request is awarded the sale of the product.

In still another aspect, the present invention is a method of fulfilling job vacancy requests of an employer. The method begins by at least one employee providing data on the employee's qualifications to a computing system. Next, the employer provides a request for a job vacancy to the computing system. The request includes a minimum qualification necessary to fill the job vacancy. The computing system then selects each employee meeting the minimum qualification of the requested job vacancy and broadcasts the request of the job vacancy to the selected employees. Next, each employee responding affirmatively to the request of the job vacancy responds to the request. The computing system then determines which employee is the first to respond affirmatively to the request and awards the job vacancy to the first selected employee to affirmatively respond to the request.

In another aspect, the present invention is a method of fulfilling product requests of a customer. The method begins by at least one supplier providing information on a product which the supplier possesses. The information includes a minimum price for which the supplier will sell the product. Next, the customer provides a request for a product to the computing system. The request sets a specific price the customer is willing to buy the product at. Next, the computing system selects each supplier which has the requested product at the specific price requested by the customer and broadcasts the product request to the selected suppliers. Next, each supplier responding affirmatively to the product request responds to the computing system.

The computing system then determines the first supplier to respond affirmatively to the product request and awards the product sale to the supplier.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram illustrating the components of a system for fulfilling staffing requests in the preferred embodiment of the present invention;

FIGS. 2A-2B are flow charts outlining the steps for inputting data into the computing system by an employee according to the teachings of the present invention;

FIGS. 3A-3D are flow charts outlining the steps for matching employees with an employer's job request and broadcasting the results to the selected employers according to the teachings of the present invention;

FIG. 4 is a simplified block diagram illustrating the components of a system for matching product requests and broadcasting the requests to selected suppliers in an alternate embodiment of the present invention; and

FIGS. 5A-5D are flow charts outlining the steps for matching suppliers with a customer's product request and broadcasting the request to the selected suppliers according to the teachings of the present invention.

### DETAILED DESCRIPTION OF EMBODIMENTS

The present invention is a system and method for fulfilling job and product requests from customers and employers.

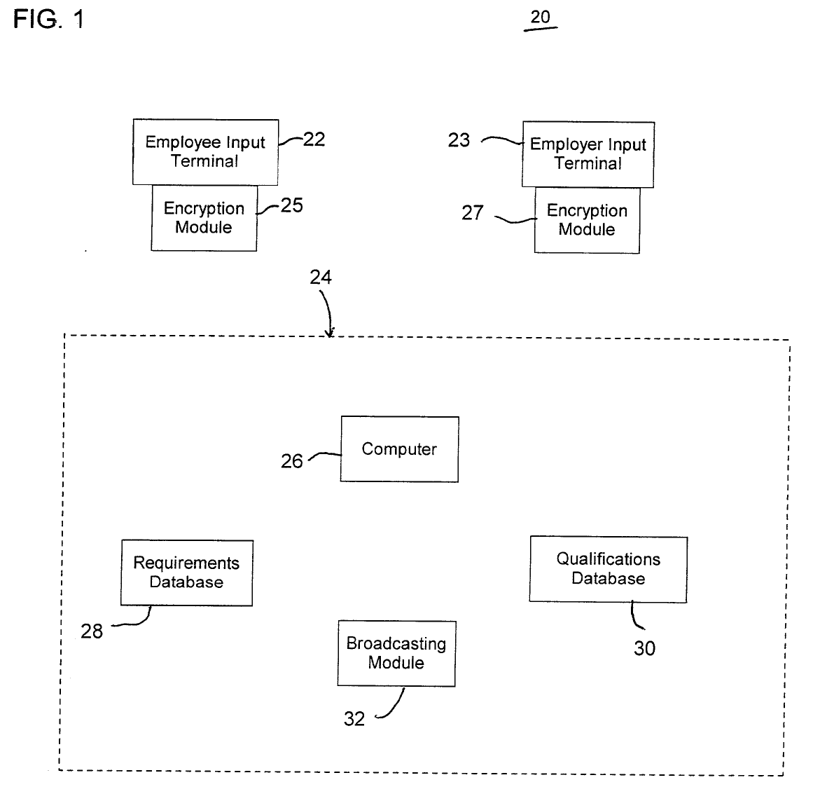

FIG. 1 is a simplified block diagram illustrating the components of a system 20 for fulfilling staffing requests in the preferred embodiment of the present invention. The system includes an employee input terminal 22 communicating with a computing system 24. Additionally, the system 20 includes an employer input terminal 23 communicating with the computing system 24. The computing system includes a computer 26, requirements database 28, a qualifications database 30, and a broadcasting module 32. In the preferred embodiment of the present invention, the components of the computing system reside in one location. However, in alternate embodiments of the present invention, the various components may be located in separate computing systems.

The employee input terminal 22 and employer input terminal 23 may be any device which allows an employee or employer to provide data to the computing system 24. The employee and employer input terminals may each include a keyboard, a touch screen, or voice recognition system. In another alternate embodiment, each input terminal may be a conventional personal data assistant (PDA). Each terminal may be wired directly to the computing system 24 or communicate via wireless communications, which is well known in radio telecommunications systems. It must be understood, that any device may be used which can effectively transfer data between an employee/employer and the computing system 24. Additionally, the inputted data may be encrypted for secure transmission to the computer. The input terminals may include terminal encryption modules 25 and 27 to encrypt data prior to transmission to the computing system. In the preferred embodiment of the present invention, each input terminal may communicate with the computing system via the Internet.

In the preferred embodiment of the present invention, the computing system 24 may be any conventional computer having the necessary computing power to store data within one or more databases and provide calculations and correlations based on the stored and inputted data.

The computing system includes a computer 26 providing correlating and matching functions of the inputted data received from the employee and employer input terminals. The computer 26 stores data inputted by the employee input terminal 22 in the qualifications database 30. Additionally, the computer 26 stores data inputted by the employer input terminal 23 into the requirements database 28.

The computer correlates and matches data from both the employee input terminal 22 and the employer input terminal 23 to create matching results. The matching results includes a list of selected employees meeting a qualification criterion requested by the employer via the employer input terminal 23. The matching results are then sent to the broadcasting module 32. The broadcasting module broadcasts the job descriptions to the selected employees meeting the qualifications requested by the employer. The broadcasting module determines the preferred mode of communication and location by a lookup table having information on the employee. For example, employee A may prefer to be notified of specific job openings via email, while employee B may prefer to be notified via mobile phone. In most cases, the selected employees are informed of the job openings which includes a basic description of the job. However, in alternate embodiments of the present invention, a basic description may not be given or a more detailed description may be immediately available to the employees. The employee is prompted to accept or reject the job opening. The first employee to respond affirmatively to the job opening is granted the job. The broadcasting module receives the responses from the employees to determine which employee is granted the job (i.e., the first employee responding affirmatively to the prompt). The employee may respond by a preferred mode of communication, or any alternate form of communication to the broadcasting module. Additionally, the computing system and broadcasting module may include the capability of receiving data via the telephone utilizing voice response systems well known in the art of telephony. The broadcasting module then immediately notifies the employer that the job opening is filled as well as notifying the employee that the job has been awarded to that employee.

The broadcasting module 32 then sends the name of the first responding employee to the computer 26. In the preferred embodiment of present invention, the computer awards the job vacancy to the first employee to respond affirmatively. However, in an alternate embodiment of the present invention, the computer may select an employee based on different criteria. For example, a specific pool of preferred employees may be given priority over other employees when awarding a job. The computer may award the first preferred employee from the specified group the job. If no preferred employee responds, after a selected period of time, another employee not from the specific pool may then be chosen. In still another embodiment, the employee with the best qualifications may be awarded the job, rather than the first to reply. It must be understood, that the system 20 provides for the selective determination of the employee to fill the job vacancy. This selectivity is both flexible and automatic. Also, in an alternate embodiment of the present invention, the employer may be presented a list of employees replying affirmatively. The employer, or some third party, may selected the employee to fill the job vacancy. Once the employee is selected by the computer (or employer, third party, etc.), the computer 26 may optionally retrieve more specific data on the job opening (e.g., location of job, wages, description of work, etc.) from the requirements database 28 and may send the specific data to the selected employee via the broadcasting module. Additionally, the computer may optionally send specific data on the employee (e.g., name, phone number, social security number, etc.) retrieved from the qualifications database 30 to the employer via the broadcasting module.

The computing system 24 may also be optionally utilized to track employee hours and assist in payment to the employee, such as electronically paying earned wages into a bank account selected by the employee. Additionally, the computing system may determine and bill the employer for the services provided, such as billing for hours worked by the employee. In the preferred embodiment of the present invention, the system 20 charges an additional fee per hour for filling any vacancies of the employer. However, in alternate embodiments of the present invention, the fee charged to the employer may be calculated in a different fashion (e.g., flat fee).

The system 20 may optionally allow employees to access a personal profile database providing past and future work schedules. Additionally, the system 20 may allow the employee to revise qualification data such as salary range, bank account information, and communication mode preferences.

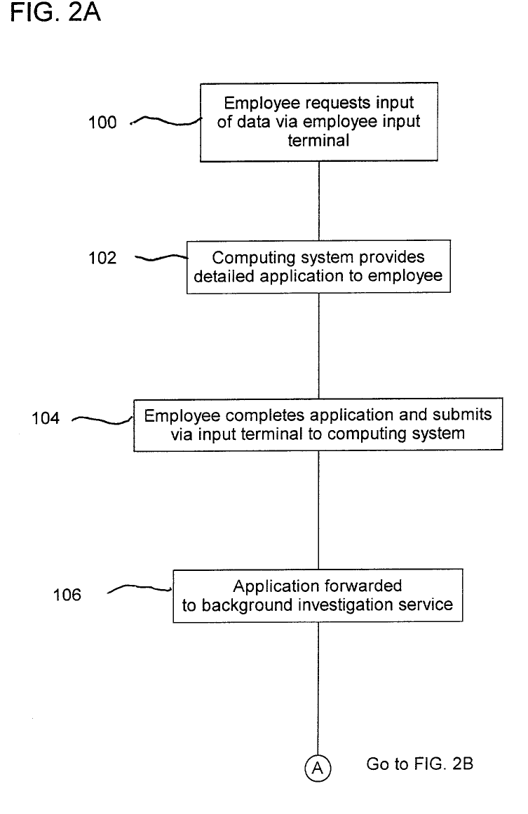

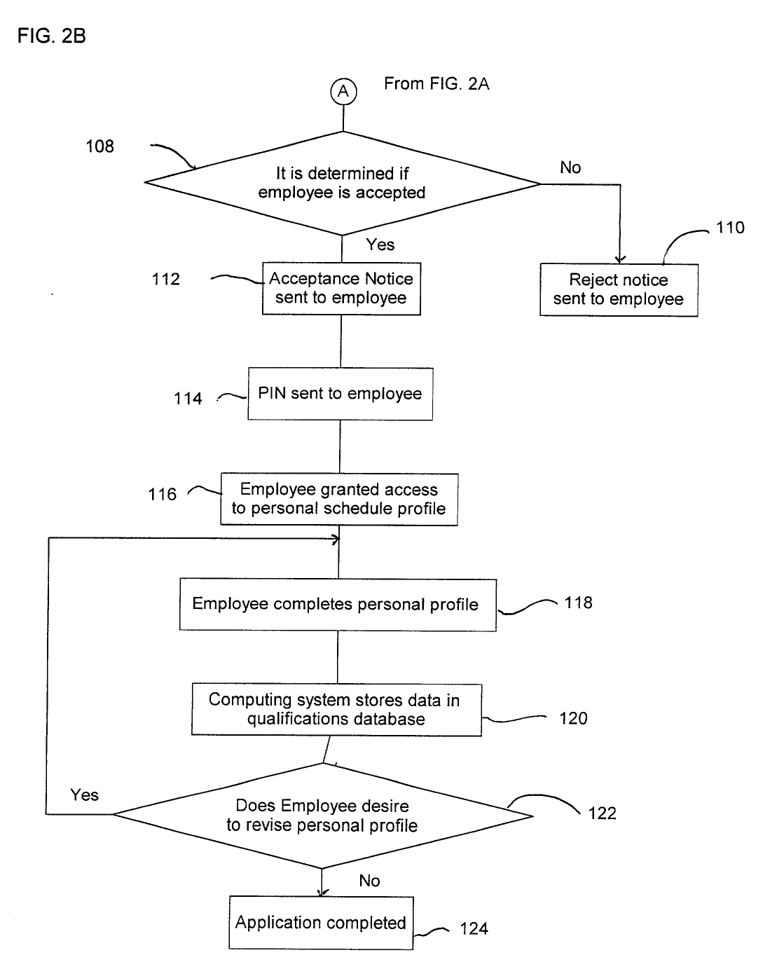

FIGS. 2A-2B are flow charts outlining the steps for inputting data into the computing system 24 by an employee A according to the teachings of the present invention. With reference to FIGS. 1, 2A and 2B, the steps of the method will now be explained. The method begins with step 100, where the employee A requests an initial job application from the computing system 24 via the employee input terminal 22. Next, in step 102, the computing system 24 provides a detailed initial application to the employee A via the employee input terminal. The detailed application may include such information that the system 20 deems necessary to match the skills of the employee A with any job openings. For example, information requested may include education, skills, prior experience, social security number, etc. In step 104, the employee A fills out the detailed application and submits it to the system 20. In the preferred embodiment of the present invention, the employee A fills out the information via the employee input terminal, however, the system 20 may manually accept applications, such as via printed hard copy or telephone. Next, in step 106, the system 20 optionally forwards the completed application of employee A to a background investigation service. The background investigation service may determine the veracity of the information provided by the employee, including a background criminal check. The background investigation service then provides the system 20 with the requested results of the background check.

Then, in step 108, it is determined by the system 20 if the employee A is approved for staffing within the system 20. If the system 20 determines that the employee A is not approved (for such reasons as a criminal record), the method moves to step 110 where the system 20 sends a notice to the employee A that he is rejected. However, if it is determine that the employee is approved, the method moves from step 108 to step 112, where the employee A is notified that he is accepted.

Next, in step 114, the employee A is assigned a personal identification number (PIN), which allows access to a personal profile established for the employee A. In step 116, the employee A is granted access to the personal profile by inputting the PIN into the employee input terminal 22. In step 118, the employee A completes or revises the personal profile. The personal profile includes preferences of the employee A, such as hours to be worked each week, days available, salary range, range of work locations, undesirable work locations, and desired method of communication (e.g., fax, beeper, mobile phone, computer, etc.). In step 120, the computing system 24 receives the inputted personal profile and stores the data within the qualifications database 30.

The method then moves to step 122 where it is determined if the employee A desires to revise the personal profile. If the employee does not desire to change the personal profile, the method moves to step 124 where the method is complete. However, if it is determined that the employee A desires to revise the personal profile, the method moves from step 122 to step 118 where the employee A revises the personal profile.

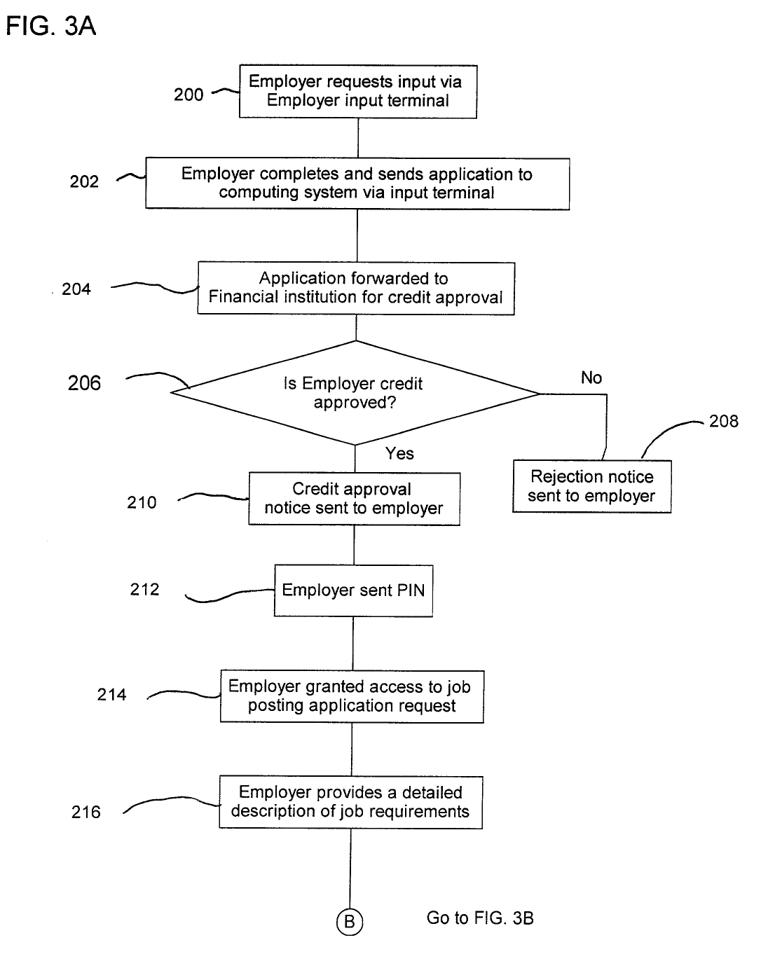

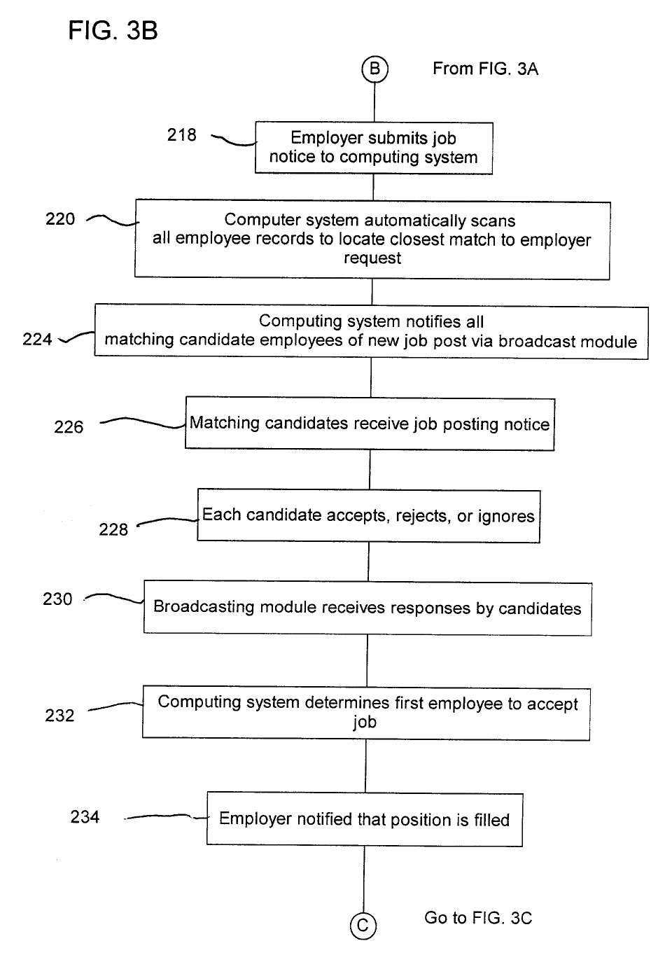

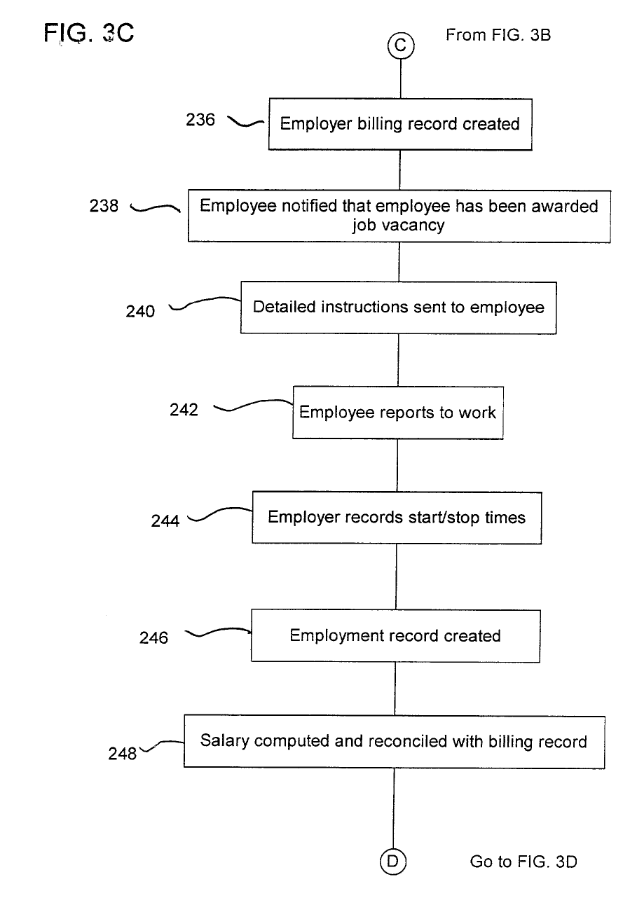

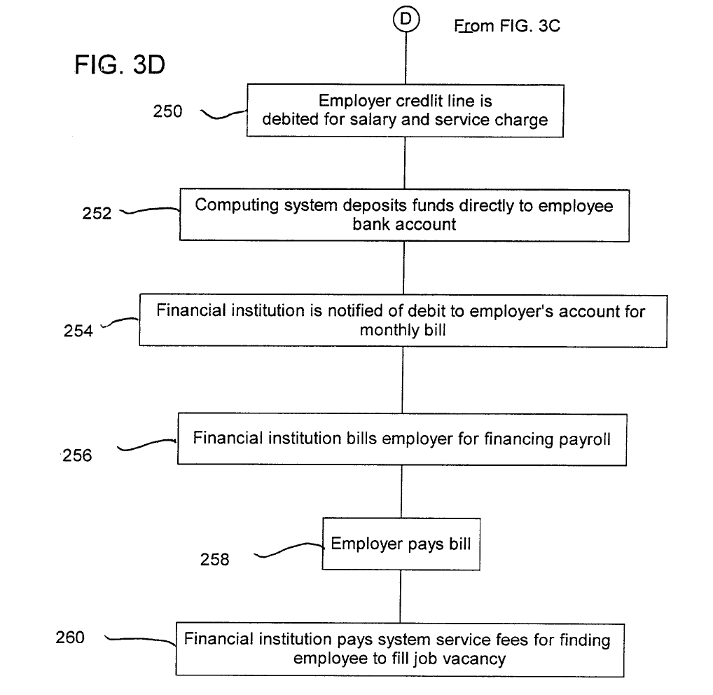

FIGS. 3A-3D are flow charts outlining the steps for matching employees with an employer's job request and broadcasting the results to the selected employers according to the teachings of the present invention. With reference to FIGS. 1, 3A, 3B, 3C, and 3D, the method will now be explained. The method begins with step 200 where an employer Z requests an application to the system 20 via the employer input terminal 23. Next, in step 202, the employer completes the application and sends the completed application to the computing system 24 via the employer input terminal. In step 204, the completed application is forwarded to a financial institution for credit approval. The financial terminal then determines if the employer Z has acceptable credit, using techniques well now in the credit industry. The financial institution provides a credit summary and recommendation to the system 20.

In step 206, it is determined by the computing system 24 utilizing the credit report received from the financial institution whether the employer Z's has approved credit. If the computing system determines that the employer Z is rejected, the method moves to step 208 where the system 20 sends a credit rejection notice to the employer Z. The notice may be sent through the employer input terminal, via voice, fax, mail, or any other means providing notification to the employer Z. However, if the employer Z is approved, the method moves from step 206 to step 210 where a credit approval notice is sent to the employer Z. As with the rejection notice, the approval notice may be sent through employer input terminal, via voice, fax, mail, or any other means providing notification to the employer Z. The credit approval process is optional. If a credit/debit system is not utilized by the system, the employer Z may not be required to complete a credit check. In alternate embodiments of the present invention, the employer Z may provide a deposit account having a specified amount of money within the account, or completely forego providing any credit payments (e.g., employee salary or service fees charged by the system 20 are paid at a later time).

Next, in step 212, the computing system 24 sends a unique PIN to the employer Z. In step 214, the employer Z may communicate and request service from the system 20 by utilizing the PIN. In step 216, the employer Z may include a detailed description of job requirements which may include shift, days, specific tasks, salary offer, contact name, special notes, and any required qualifications. The method then moves to step 218, where the employer Z submits a job notice request to the computing system 24. In step 220, the computing system receives the job notice and stores the data associated with the job notice request in the requirements database 28. Additionally, the computing system automatically scans all employee records located in the qualifications database 30. Only those employees submitting an application such as that described in FIGS. 2A-2B have records stored within the qualifications database. The computing system creates a list of all employees matching the requirements submitted by the employer Z in the job request.

In step 224, the computing system 24 then notifies all matching employee candidates of the job notice request of employer Z via the broadcasting module 32. The job notice request is sent to each employee candidate via the preferred mode of communication selected by each employee (e.g., fax, mobile phone, beeper, e-mail, etc.). Next, in step 226, each matching employee candidate receives the job notice request with all relevant information. The relevant information may be only that information which allows each employee to make an informed decision. In step 228, each matching employee candidate accepts, rejects, or ignores the job notice request. In step 230, the broadcasting module receives responses from the candidates choosing to respond (either to accept or reject). Then, in step 232, the computing system 24 determines which employee is the first to accept the job notice request. As discussed above, the computer preferably awards the job vacancy to the first employee to respond affirmatively. Alternatively, the computer may select an employee based on other criteria. For example, a specific pool of preferred employees may be given priority over other employees when awarding a job. The computer may award the first preferred employee the job. If no preferred employee responds, after a selected period of time, another employee not from the specific pool, may then be chosen. In still another embodiment, the employee with the best qualifications may be awarded the job, rather than the first to reply. Alternatively, rather than the computing system selecting the employee to fill the job vacancy from those employees responding affirmatively, the employer or some third party may select the employee from a provided list of employees responding affirmatively to the request. The system 20 provides for the selective determination of the employee to fill the job vacancy. Next, in step 234, the computing system 24 notifies the employer Z that the selected job opening is filled.

Next, in step 236, an employer billing record is created associated with the filled job opening. In step 238, the computing system 24, via the broadcasting module 32, notifies the selected employee S that the employee has been selected to fill the job opening. Although employee S has filled the job opening of employer Z, the employee S may still receive job notice requests for other job vacancies. In step 240, the computing system provides the employee S with more detailed information on the filled job opening, such as driving instructions, specific tasks to be performed, etc.

The method then moves to step 242 where the employee S reports to work for employer Z. In step 244, the employer Z records the start and stop times of the employee S and sends the times to the computing system 24. Next, in step 246, the computing system creates an employment record having the recorded start and stop times of the employee S. Additionally, any discrepancies are noted on the employment record. In step 248, the computing system calculates the salary and reconciles the salary with the billing record created in step 236. The method then moves to step 250, where the employer Z's credit line is optionally debited, if the employer Z has a credit line established in steps 200-210.

Next, in step 252, the computing system 24 may optionally send the calculated salary via direct deposit to the employee S's requested bank account. In an alternate embodiment of the present invention, the system 20 may mail payments directly to the employee S. Additionally, the system 20 may transfer funds optionally collected in a deposit account established by the system to the employee Z. In step 254, the financial institution utilized in establishing a credit account for the employer Z may be notified of the completion of employment by the employee Z. The financial institution may then debit the employer Z's account the appropriate amount, including salary for the employee S. Additionally, the debited amounted is added to a monthly bill. Next, in step 256, if utilizing the credit account, the financial institution bills the employer Z, preferably through a monthly billing system. However, any billing scheme may be utilized which allows proper transfer of funds from the employer Z to the system 20 and the employee S. In step 258, employer Z pays the bill to either the financial institution, the system 20, or directly to employee S, depending on the billing schemed used. The method then moves from step 258 to 260 where, if the financial institution is utilized for payment by the employer Z, the financial institution pays the system 20 the service fees due for filling the job vacancy of employer Z.

As discussed above, a variety of methods may be used for payment from the employer to the system 20 and the employee S. The preferred embodiment of the present invention utilizes the credit system of a financial institution, thus providing an electronic transfer of funds. This provides an efficient and cost-effective way of paying the various parties involved in the filling of a job vacancy. However, other methods may be used, such as direct cash payment, a credit system internally managed and operated by the system 20, or any other method allowing the transfer of funds from one party to another.

If no employee candidates can be found which are willing to work in the request job opening, after a predetermined period of time, the system may employ the services of an existing temporary staffing agency using manual contact methods to gain the acceptance of an employee. This allows the vacancy to be filled, usually resulting in premium service charges being earned by the temporary staffing agency.

Although a temporary staffing scenario is discussed, the system 20 may be used in other saturations. For example, a plurality of employees associated with a group employer may find the system 20 useful. Although the employees may be permanently employed, the system 20 allows the employees to fill vacancies located with the group employers.

The system 20 provides many advantages over the existing temporary staffing systems. Currently, the fulfillment of temporary job openings must be completed manually, which involves many man hours, reducing the efficiency and increasing the costs associated with staffing agencies. The system 20 allows a plurality of employees to be automatically matched to temporary job vacancies in a timely, and cost-effective manner. The system completely eliminates the tedious task of querying each and every qualified candidate to determine if they would wish to accept the job vacancy. Additionally, the system allows a computing system to automatically determine which employees are qualified to fill the requested job vacancy. In the preferred embodiment of the present invention, the system utilizes a credit transaction system with a financial institution, which is well known in the art of credit transactions. By using a credit transaction system with the system 20, electronic transfer of money can be accomplished, thereby reducing administrative costs and reducing time between the accomplishment of the employee S's job and payment to the employee and the system 20.

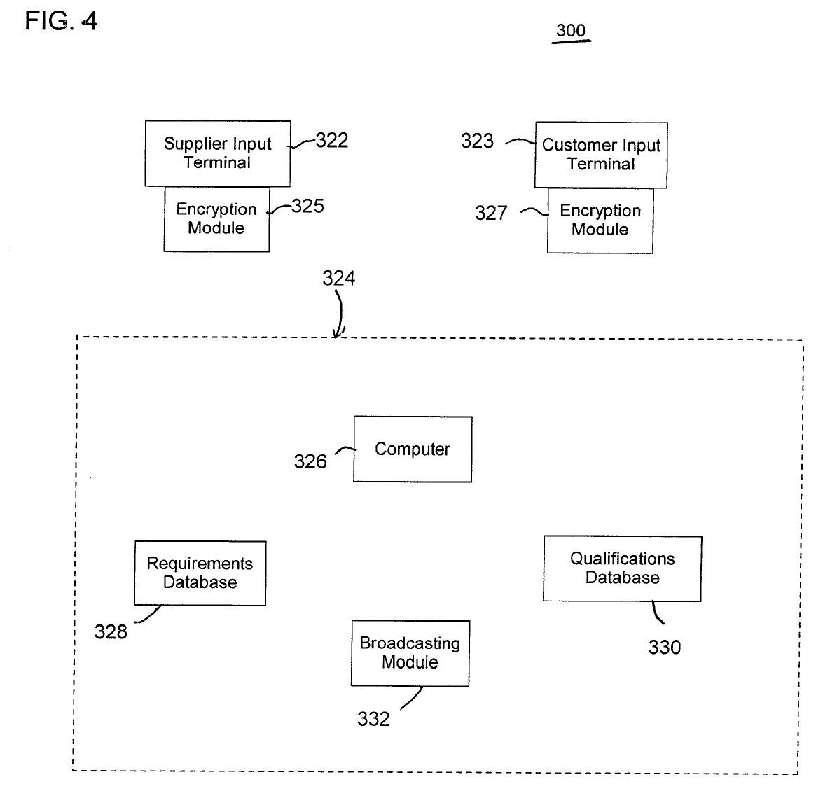

Although the preferred embodiment of the present invention is used in the temporary staffing industry, the present invention may also be used in other areas. For example, the present invention may be used to buy and transfer products from a supplier to a customer. FIG. 4 is a simplified block diagram illustrating the components of a system 300 for matching product requests and broadcasting the requests to selected suppliers in an alternate embodiment of the present invention. The system includes a supplier input terminal 322 communicating with a computing system 324. Additionally, the system 300 includes a customer input terminal 323 communicating with the computing system 324. The computing system includes a computer 326, requirements database 328, a qualifications database 330, and a broadcasting module 332. The components of the computing system may reside in one or more locations.

The supplier input terminal 322 and customer input terminal 323 may be any device which allows a customer or supplier to communicate with the computing system 324. The customer and supplier input terminals may each include a keyboard, a touch screen, PDA, or voice recognition system. Each terminal may be wired directly to the computing system 324 or communicate via wireless communications, which is well known in radio telecommunication systems. It must be understood, that any device may be used which can effectively transfer desired data to the computing system 324. Additionally, the inputted data may be encrypted for secure transmission to the computer. The input terminals may each include terminal encryption modules 325 and 327 to encrypt data prior to transmission. In the preferred embodiment of the present invention, each input terminal may communicate with the computing system via the Internet.

In the preferred embodiment of the present invention, the computing system 324 may be any conventional computer having the necessary computing power to store data within one or more databases and provide calculations and correlations based on the stored and inputted data.

The computing system includes a computer 326 providing correlating and matching functions of the inputted data received from the supplier and customer terminals. The computer 326 stores data inputted by the supplier terminal 322 in the qualifications database 330. Additionally, the computer 326 stores data inputted by the customer terminal 323 into the requirements database 328.

The computer correlates and matches data from both the supplier input terminal 322 and the customer input terminal 323 to create matching results. The matching results includes a list of selected suppliers having products meeting qualification data sets inputted by the customer into the customer input terminal 323. The matching results are sent to the broadcasting module 332. The broadcasting module broadcasts the product descriptions to the selected suppliers meeting the qualifications requested by the customer. The broadcasting module determines the preferred mode of communication and location by a lookup table providing information on the supplier. For example, supplier C may prefer to be notified of specific product requests via telephone, while supplier D may prefer to be notified via a pager. In all cases, the selected suppliers are informed of the product requests, including a basic description of the desired product (price request, specified item, condition, etc.). The supplier is prompted to accept or reject the request for a product. Preferably, the first supplier to respond affirmatively to the product request is granted the sale of the product at the price listed in the product request by the customer. However, in alternate embodiments of the present invention, other criteria may be used to determine which supplier is selected. Additionally, the customer or a third party may be provided the list of affirmatively responding suppliers and select the supplier to fill the product request. For example, the supplier having the lowest price of a product may be selected. The broadcasting module receives the responses from the suppliers to determine which supplier is granted the sale of the product (i.e., the first supplier responding affirmatively to the prompt). The broadcasting module then immediately notifies the customer that the product request has been accepted. Additionally, the supplier is notified that the product sale has been awarded to the supplier.

The broadcasting module 332 then sends the name of the first responding supplier to the computer 326. The computer 326 then retrieves more specific data on the product (e.g., delivery method, time, location of delivery, etc.) from the requirements database 328 and sends the specific data to the selected supplier via the broadcasting module. Additionally, the computer may optionally send specific data on the supplier (e.g., name, phone number, address, etc.) retrieved from the qualifications database 330 to the customer via the broadcasting module.

The computing system 324 may also optionally track the supplier's location of product, estimated and actual time of delivery and may assist in the transfer of payment to the supplier, such as through the electronic payment on the sale of the product into a bank account selected by the supplier. Additionally, the computing system may determine and bill the customer for the products provided. The system 300 may also charge an additional service fee for finding the customer the correct product. In an alternate embodiment of the present invention, a fee may also be charged to the supplier for finding a buyer for the product of the supplier.

The system 300 may optionally allow suppliers to access a personal profile providing past product sales. Additionally, the system 300 may allow the supplier to revise qualifications data for each product prior to acceptance by a customer, as well as bank account information and communication mode preferences.

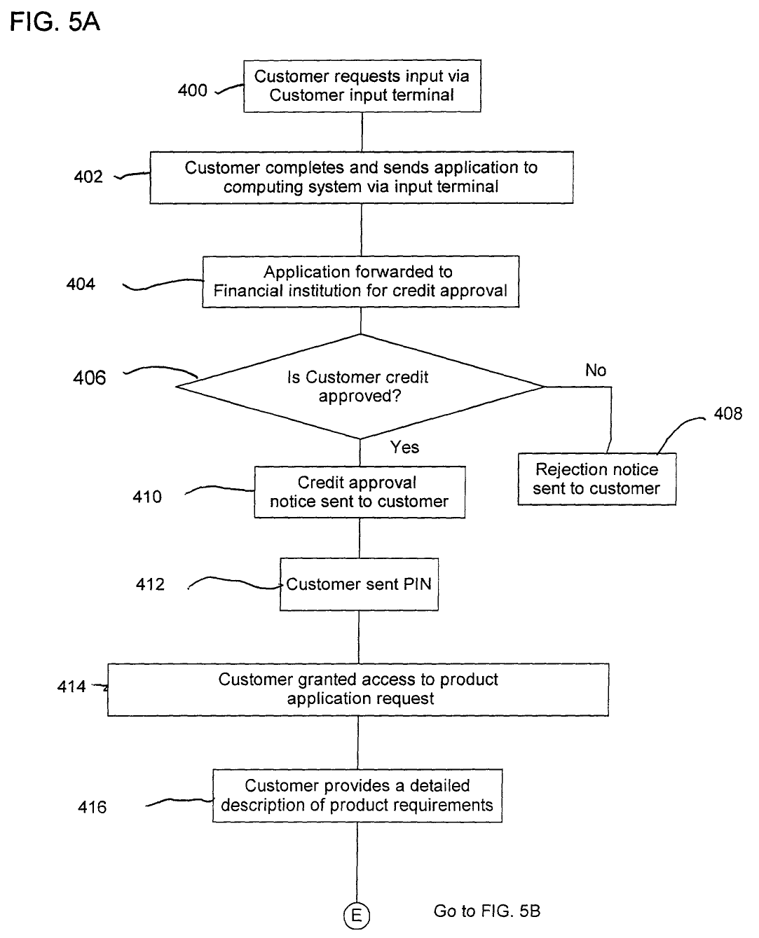

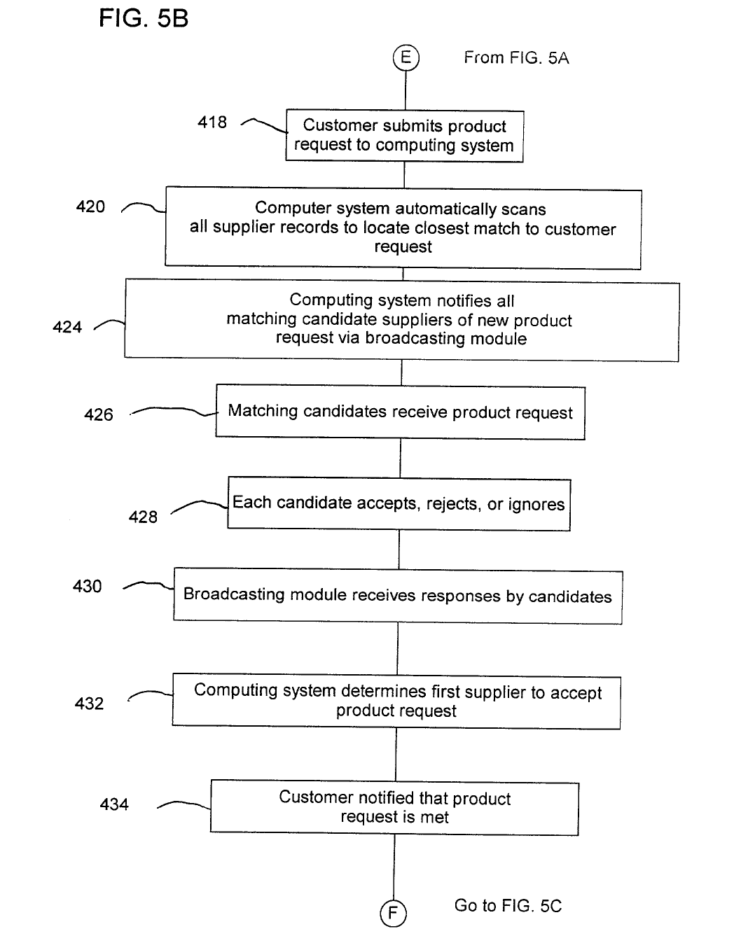

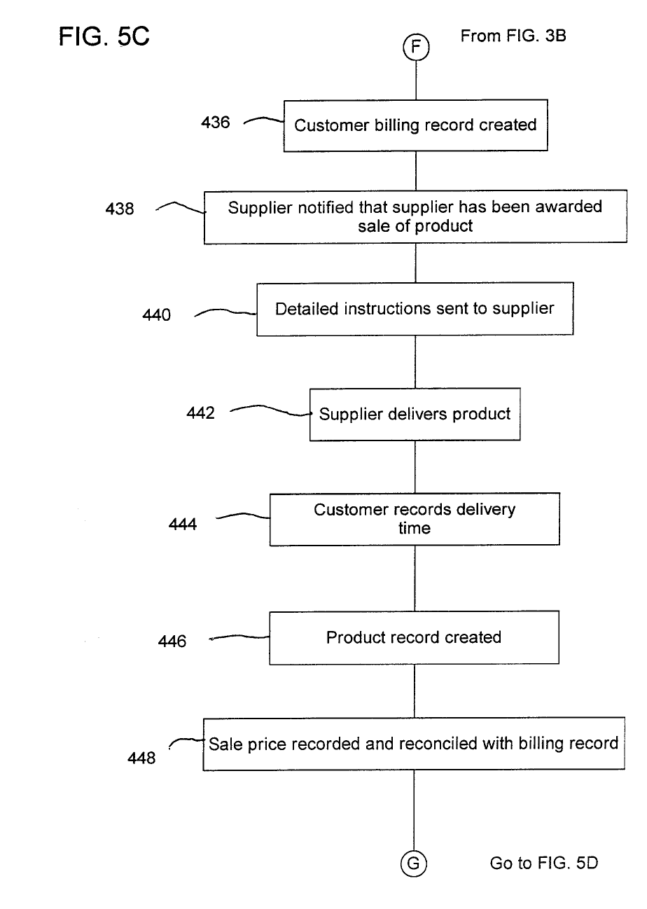

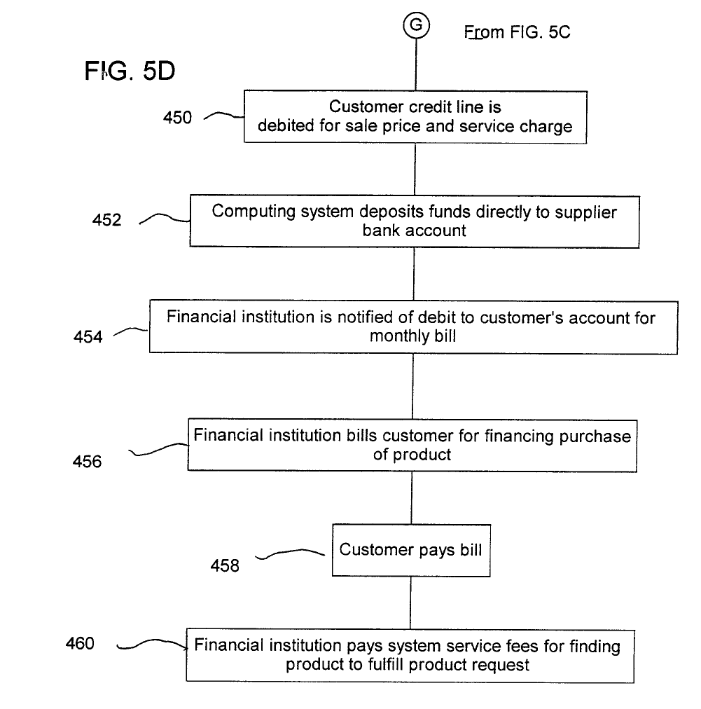

FIGS. 5A-5D are flow charts outlining the steps for matching suppliers with a customer's product request and broadcasting the request to the selected suppliers according to the teachings of the present invention. With reference to FIGS. 4, 5A, 5B, 5C, and 5D, the method will now be explained. The method begins with step 400 where a customer Y requests an application to the system 300 via the customer input terminal 323. In step 402, the customer completes the application and sends the completed application to the computing system 324 via the customer input terminal. In step 404, the completed application is optionally forwarded to a financial institution for credit approval. The financial institution then determines if the customer Y has acceptable credit, using techniques well known in the credit industry. The financial institution provides a credit summary and recommendation to the system 300.

Next, in step 406, it is determined by the computing system 324 utilizing the credit report received from the financial institution whether the customer Y's has approved credit. If the computing system determines that the customer Y is rejected, the method moves to step 408 where the system 300 sends a credit rejection notice to the customer Y. The notice may be sent through the customer input terminal, via voice, fax, mail, or any other means providing notification to the customer Y. However, if the customer Y is approved, the method moves from step 406 to step 410 where a credit approval notice is sent to the customer Y. As with the rejection notice, the approval notice may be sent through the customer input terminal, via voice, fax, mail, or any other means providing notification to the customer Z. The credit approval process is optional. If a credit/debit system is not utilized by the system, the customer Y may not be required to complete a credit check. In alternate embodiments of the present invention, the customer Z may provide a deposit to a deposit account having a specified amount of money within the account, or completely forego providing any credit payments (e.g., monthly statements).

Next, in step 412, the computing system 324 sends a PIN to the customer Y. In step 414, the customer Y may communicate and request service from the system 300 by utilizing the PIN. In step 416, the customer Y may include a detailed description of the requested product which may include category, brand, condition, price range, contact name, and special notes. The method then moves to step 418, where the customer Y submits a product request to the computing system 324. In step 420, the computing system receives the product request and stores the data associated with the product request in the requirements database 328. Additionally, the computing system automatically scans all supplier records located in the qualifications database 330. Suppliers provide the system 300 with the products available from each supplier. The suppliers listed products are stored in the qualifications database 330. The computing system creates a list of all suppliers having products matching the requested products submitted by the customer Y in the product request.

In step 424, the computing system 324 then notifies all matching supplier candidates of the product request of customer Y via the broadcasting module 332. The product request is sent to each supplier candidate via the preferred mode of communication selected by each supplier (e.g., fax, mobile phone, beeper, email, etc.). Next, in step 426, each matching supplier candidate receives the job notice request with all relevant information. The relevant information may be only that information which allows each supplier to make an informed decision. In step 428, each matching supplier candidate accepts, rejects, or ignores the product request. In step 430, the broadcasting module receives responses from the candidates choosing to respond (either to accept or reject). Then, in step 432, the computing system 324 determines which supplier is the first to accept the product request. As with the embodiment described in FIGS. 3A-3D, the computer preferably awards the product request to the first supplier to respond affirmatively. However, in an alternate embodiment of the present invention, the computer may select a supplier based on different criteria. For example, a specific pool of preferred suppliers may be given priority over other suppliers when awarding a job. The computer may award the first preferred supplier from the specific pool the sale of the product. If no preferred supplier responds, after a selected period of time, another supplier, not from the specific pool, may then be chosen. In still another embodiment, the supplier having the product in the best condition, or at the lowest price, is awarded the sale of the product, rather than the first to reply. In still another embodiment of the present invention, a list of all affirmatively responding suppliers may be given to the customer or a third party. The customer or third party, rather than the computing system may then determine the supplier to fill the product request. It must be understood, that the system 300 provides for the selective determination of the supplier to fill the product request. This selectivity is both flexible and automatic. Next, in step 434, the computing system 324 notifies the customer Y that the selected product is available and the request has been fulfilled.

Next, in step 436, an customer billing record is created and associated with the fulfilled product request. In step 438, the computing system 324, via the broadcasting module 332, notifies the selected supplier T that the supplier has been selected to fulfill the product request. Although the supplier T has filled the specific job opening of customer Y, the supplier T may still receive product requests for other products. In step 440, the computing system provides the supplier T with more detailed information on the product request, such as exact location for delivery of product, time, special notes, etc.

The method then moves to step 442 where the supplier T sends the product to customer Y. In step 444, the customer Y records the delivery of the product and time of delivery to the customer Y from the supplier T. This data is sent to the computing system 324. Next, in step 446, the computing system creates a product record acknowledging receipt of the product and delivery. Additionally, any discrepancies are noted on the product record, such as damaged goods or late delivery. In step 448, the computing system calculates the price of the product and reconciles the price with the billing record created in step 436. The method then moves to step 450, where the customer Y's credit line is optionally debited, if the customer Y has an established credit line.

Next, in step 452, the computing system 324 may optionally send the calculated payment via direct deposit to the supplier T's requested bank account. In an alternate embodiment of the present invention, the system 300 may mail payment directly to the supplier T. Additionally, the system 300 may transfer funds optionally collected in deposit by the system to the supplier Y. In step 454, the financial institution utilized in establishing a credit account for the customer Y may be notified of the fulfillment of the product request by the supplier Y and debit the customer Y's account the appropriate amount, including the listed price of the product for the supplier T. Additionally, the debited amounted is added to a monthly bill. Next, in step 456, if utilizing the credit account, the financial institution bills the customer Y, preferably through a monthly billing system. However, a billing scheme may be utilized which allows proper transfer of funds from the customer Y to the system 300. In step 458, customer Y pays the bill to either the financial institution or the system 300, depending on the billing schemed used. The method then moves from step 458 to step 460 where, if the financial institution is utilized for payment by the customer Y, the financial institution pays the system 300 the service fees due for fulfilling the product request of customer Y.

As discussed above, in a similar fashion as system 20, a variety of methods may be used for payment from the customer to the system 300 and the supplier T. The preferred embodiment of the present invention utilizes the credit system with a financial institution, thus providing an electronic transfer of funds. However, other methods may be used, such as direct cash payment, a credit system internally managed and operated by the system 300, or any other method allowing the transfer of funds from one party to another.

The system 300 provides an efficient method of notifying a plurality of potential suppliers of the product request of a customer. The system 300 automatically matches the requests of the customer with the products of the suppliers, thus increasing the chance of a sale of a product. In addition, product requests are broadcasted to the plurality of selected suppliers, thereby reducing the work required in manually contacting each supplier individually.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for fulfilling staffing requests of an employer, said system comprising:
a computing system;
a first input terminal for communicating between at least one employee and the computing system, each employee providing data on the employee's qualifications;
a second input terminal for communicating between the employer and the computing system, the employer providing a request for a job vacancy to be filled to said computing system, said request setting a minimum qualification necessary to fill the job vacancy;
said computing system having means for selecting each employee qualified to fill the job vacancy of the employer;
a broadcasting module for broadcasting to the selected employees an offer of the job vacancy;
means for each employee to respond to the offer of the job vacancy;
means for determining all employees who accept the offer of the job vacancy; and
means for selecting a specified employee to fill the job vacancy by selecting an employee who accepts the offer and meets a specified criterion;
whereby the computing system awards the job vacancy to the specified employee.

2. The system for fulfilling staffing requests of claim 1 wherein the specified criterion is based on the employee exceeding the minimum qualification by the largest margin.

3. The system for fulfilling staffing requests of claim 1 wherein the specified criterion is based on selected employees being associated with a selected group.

4. The system for fulfilling staffing requests of claim 1 wherein the specified criterion is based on the employee living closest to a location of the job vacancy.

5. The system for fulfilling staffing requests of claim 1 wherein the specified criterion is based on the first employee to accept the offer.

6. The system for fulfilling staffing requests of claim 1 wherein the first input terminal is a telephone connected to the computing system, said computing system having voice recognition means for communicating with the employee.

7. The system for fulfilling staffing requests of claim 1 wherein the first input terminal is a computer connected to the Internet, said computing system connected to the Internet and communicating via the Internet with said first input terminal.

8. The system for fulfilling staffing requests of claim 1 wherein the second input terminal is a telephone connected to the computing system, said computing system having voice recognition means for communicating with the employer.

9. The system for fulfilling staffing requests of claim 1 wherein the second input terminal is a computer connected to the Internet, said computing system connected to the Internet and communicating via the Internet with said second input terminal.

10. The system for fulfilling staffing requests of claim 1 wherein the job vacancy is designated to be filled for a specific period of time.

11. The system for fulfilling staffing requests of claim 1 wherein the job vacancy is provided for a group of employees permanently employed by a company.

12. The system for fulfilling staffing requests of claim 1 wherein each employee provides a preference of the employee to the computing system via the first input terminal.

13. The system for fulfilling staffing requests of claim 12 whereby the preference is used by said computing system to determine a selected employee.

14. The system for fulfilling staffing requests of claim 1 wherein each employee provides the computing system with a preferred mode of communication in broadcasting the job vacancy and said broadcasting means broadcasts the job vacancy via the preferred mode of communication.

15. The system for fulfilling staffing requests of claim 1 further comprising a credit system having a third party provide payment to the selected employee and allowing the employer to pay the third party at a future time period.

16. The system for fulfilling staffing requests of claim 1 wherein the means for selecting a specified employee is determined by the computing system.

17. The system for fulfilling staffing requests of claim 1 wherein the means for selecting a specified employee is determined by the employer.

18. The system for fulfilling staffing requests of claim 1 wherein the means for selecting a specified employee is determined by a third party.

19. A system for fulfilling staffing requests of an employer, said system comprising:
a computing system;
a first input terminal for communicating between at least one employee and the computing system, each employee providing data on the employee's qualifications;
a second input terminal for communicating between the employer and the computing system, the employer providing a request for a job vacancy to be filled to said computing system, said request having a minimum qualification necessary to fill the job vacancy;
said computing system having means for selecting each employee meeting the minimum qualification of the employer;
a broadcasting module for broadcasting to the selected employees the request of the job vacancy;
means for each selected employee to respond to the request by communicating with the computing system;
means for determining all selected employees to affirmatively respond to the request; and
means for selecting a specified employee from all selected employees to affirmatively respond to the request based on a specified criterion;
whereby the computing system awards the job vacancy to the specified employee.

20. The system for fulfilling staffing requests of claim 19 further comprising a credit system having a third party provide payment to the selected employee after completion of the awarded job and allowing the employer to pay the third party at a future time period.

21. A system for fulfilling product requests of a customer, said system comprising:
a computing system;
a first input terminal for communicating between at least one supplier and the computing system, each supplier providing data on the supplier's product;
a second input terminal for communicating between the customer and the computing system, the customer providing a request for a product to said computing system;
said computing system having means for selecting each supplier having the requested product of the customer;
a broadcasting module for broadcasting to the selected suppliers the request of the product;
means for each selected supplier to respond to the request by communicating with the computing system; and
means for determining all suppliers to affirmatively respond to the request;
means for selecting a specified supplier from all suppliers to affirmatively respond to the request based on a selected criterion;
whereby the computing system awards a sale of the product to the specified supplier.

22. The system for fulfilling product requests of claim 21 wherein the means for selecting a specified supplier is determined by the computing system.

23. The system for fulfilling product requests of claim 21 wherein the means for selecting a specified supplier is determined by the customer.

24. The system for fulfilling product requests of claim 21 wherein the means for selecting a specified supplier is determined by a third party.

25. The system for fulfilling product requests of claim 21 wherein the selected criterion is based on the first supplier to affirmatively respond to the request.

26. The system for fulfilling product requests of claim 21 further comprising a credit system having a third party providing payment to the selected supplier and allowing the customer to pay the third party at a future time period.

27. A method of fulfilling job vacancy requests of an employer, said method comprising the steps of:
providing, by at least one employee, data on the employee's qualifications to a computing system;
providing, by the employer, a request for a job vacancy to the computing system, said request having a minimum qualification necessary to fill the job vacancy;
selecting, by the computing system, each employee meeting the minimum qualification of the requested job vacancy;
broadcasting, by the computing system, the request of the job vacancy to the selected employees;
responding by each employee responding affirmatively to the request of the job vacancy;
determining, by the computing system, all employees to affirmatively respond to the request;
selecting, a specified employee from all employees affirmatively responding to the request based on a selected criterion; and
awarding, by the computing system, the job vacancy to the specified employee.

28. The method of fulfilling job vacancy requests of an employer of claim 27 wherein:
the step of providing data on the employee's qualifications includes providing data on a preference of the employee; and
the step of selecting by the computing system each employee meeting the minimum qualification of the requested job vacancy includes selecting only each employee which also fulfills the employee's preference.

29. The method of fulfilling job vacancy requests of an employer of claim 27 wherein the step of selecting a specified employee includes selecting the first employee to respond affirmatively to the request.

30. The method of fulfilling job vacancy requests of an employer of claim 29, further comprising, after the step of awarding by the computing system the job vacancy to the first selected employee, the step of providing a credit by a financial institution to the employer for the completion of the job by the employee, the financial institution paying the employee for completion of the job and accepting payment from the employer at a future period of time.

31. The method of fulfilling job vacancy requests of an employer of claim 27 wherein the step of providing, by at least one employee, data on the employee's qualifications to a computing system includes encrypting the data.

32. The method of fulfilling job vacancy requests of an employer of claim 27 wherein the step of providing, by the employer, a request for a job vacancy to the computing system, said request having a minimum qualification necessary to fill the job vacancy includes encrypting the request.

33. A method of fulfilling product requests of a customer, said method comprising the steps of:
providing, by at least one supplier, information on a product which the supplier possesses, said information including a minimum price for which the supplier will sell the product;
providing, by the customer, a request for a product to the computing system, said request having a specific price the customer is willing to buy the product;
selecting, by the computing system, each supplier which has a product which the customer requests at the specific price requested by the customer;
broadcasting, by the computing system, the product request to the selected suppliers;
responding by each supplier responding affirmatively to the product request;
determining, by the computing system, all suppliers to affirmatively respond to the product request;
selecting, by the computing system, a specified supplier from all suppliers to respond affirmatively based on a selected criterion; and
awarding, by the computing system, the product request to the specified supplier.

34. The method of fulfilling product requests of a customer of claim 33 wherein the step of selecting, by the computing system, a specified supplier from all suppliers to respond affirmatively based on a selected criterion is based on the first selected supplier to respond affirmatively.

35. The method of fulfilling product requests of a customer of claim 33, further comprising, after the step of awarding by the computing system the product request to the first selected supplier, the step of providing a credit by a financial institution to the customer for transferring ownership of the product to the customer by the supplier, the financial institution paying the supplier for the product and accepting payment from the customer at a future period of time.
